(19) United States
(12) Patent Application Publication
(10) Pub. No.: US 2026/0086358 A1
(43) Pub. Date: Mar. 26, 2026

(54) DISPLAY SYSTEM

(71) Applicant: Panasonic Automotive Systems Co., Ltd., Kanagawa (JP)

(72) Inventors: Norihiro IMAMURA, Osaka (JP); Kenji NAGATOMI, Osaka (JP); Yusuke NIHEI, Tokyo (JP); Michihiro YAMAGATA, Osaka (JP); Keiichi MATSUZAKI, Kyoto (JP)

(73) Assignee: Panasonic Automotive Systems Co., Ltd., Kanagawa (JP)

(21) Appl. No.: 19/319,964

(22) Filed: Sep. 5, 2025

(30) Foreign Application Priority Data
Sep. 26, 2024 (JP) 2024-167369
Apr. 22, 2025 (JP) 2025-070365

(51) Int. Cl. G02B 27/01; B60K 35/235

(52) U.S. Cl. CPC G02B 27/0101; B60K 35/235; B60K 2360/178; G02B 2027/0141

(57) ABSTRACT

A display system includes: a first display device that projects a first virtual image in front of a user aboard a vehicle; and a second display device that projects a second virtual image in front of the user, wherein the first display device is a head-up display or an electronic mirror-type display device, and a first viewing distance from the user to the first virtual image is less than a second viewing distance from the user to the second virtual image.

### CROSS REFERENCE TO RELATED APPLICATIONS

The present application is based on and claims priority of Japanese Patent Application No. 2024-167369 filed on Sep. 26, 2024, and Japanese Patent Application No. 2025-070365 filed on Apr. 22, 2025.

### FIELD

The present disclosure relates to a display system.

### BACKGROUND

Patent Literature (PTL) 1 discloses a display system in which a first virtual image and a second virtual image are projected in front of a user. In PTL 1, the first virtual image is projected by a head-up display, and a second viewing distance between the second virtual image and the user's viewpoint is less than or equal to a first viewing distance between the first virtual image and the user's viewpoint.

### CITATION LIST

### Patent Literature

PTL 1: Japanese Unexamined Patent Application Publication No. 2015-146012

### SUMMARY

However, the foregoing display system can be improved upon.

In view of this, the present disclosure provides a display system capable of improving upon the above related art.

A display system according to one aspect of the present disclosure includes: a first display device that projects a first virtual image in front of a user aboard a vehicle; and a second display device that projects a second virtual image in front of the user, wherein the first display device is a head-up display or an electronic mirror-type display device, and a first viewing distance from the user to the first virtual image is less than a second viewing distance from the user to the second virtual image.

A display system according to one aspect of the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a schematic diagram illustrating a state in which a display system according to Embodiment 1 is provided in a vehicle.

FIG. 2 is a schematic diagram illustrating a first display device and a second display device included in the display system according to Embodiment 1.

FIG. 3A is an explanatory diagram illustrating the movement of a driver's line of sight for a first virtual image and a second virtual image according to Embodiment 1.

FIG. 3B is an explanatory diagram illustrating the movement of the driver's line of sight for the first virtual image and the second virtual image according to a conventional example.

FIG. 4 is an explanatory diagram illustrating a first display example of the second virtual image according to Embodiment 1.

FIG. 5 is an explanatory diagram illustrating a second display example of the second virtual image according to Embodiment 1.

FIG. 6 is an explanatory diagram illustrating a third display example of the second virtual image according to Embodiment 1.

FIG. 7 is a schematic diagram illustrating a state in which a display system according to Embodiment 2 is provided in a vehicle.

FIG. 8 is a schematic diagram illustrating an electronic mirror-type display device according to Embodiment 2.

FIG. 9 is a schematic diagram illustrating a state in which a display system according to Embodiment 4 is provided in a vehicle.

FIG. 10 is a schematic diagram illustrating a state in which a display system according to Embodiment 5 is provided in a vehicle.

FIG. 11A is an explanatory diagram illustrating a display example according to Embodiment 6.

FIG. 11B is an explanatory diagram illustrating a display example according to Embodiment 6.

FIG. 11C is an explanatory diagram illustrating a display example according to Embodiment 6.

FIG. 12 is an explanatory diagram illustrating a display example according to Embodiment 7.

FIG. 13 is an explanatory diagram illustrating a display example according to Embodiment 8.

FIG. 14A is an explanatory diagram illustrating a display example according to Embodiment 9.

FIG. 14B is an explanatory diagram illustrating a display example according to Embodiment 9.

FIG. 15A is an explanatory diagram illustrating a display example according to Embodiment 10.

FIG. 15B is an explanatory diagram illustrating a display example according to Embodiment 10.

FIG. 16A is an explanatory diagram illustrating a display example according to Embodiment 11.

FIG. 16B is an explanatory diagram illustrating a display example according to Embodiment 11.

FIG. 16C is an explanatory diagram illustrating a display example according to Embodiment 11.

FIG. 17 is an explanatory diagram illustrating another display example according to Embodiment 11.

FIG. 18 is a schematic diagram illustrating a display system according to Embodiment 12.

FIG. 19 is an explanatory diagram illustrating a display example according to Embodiment 12.

FIG. 20 is a schematic diagram illustrating a display system according to Embodiment 13.

### DESCRIPTION OF EMBODIMENTS

### Underlying Knowledge Forming Basis of the Present Disclosure

In recent years, there has been a demand for further reducing the burden on users when viewing different virtual images. The present disclosure accordingly provides a display system capable of reducing a user's burden when viewing different virtual images.

(1) A display system according to one aspect of the present disclosure includes: a first display device that projects a first virtual image in front of a user aboard a vehicle; and a second display device that projects a second virtual image in front of the user, wherein the first display device is a head-up display or an electronic mirror-type display device, and a first viewing distance from the user to the first virtual image is less than a second viewing distance from the user to the second virtual image.

In the display system according to (1), the first viewing distance from the user to the first virtual image is less than the second viewing distance from the user to the second virtual image. As a result, when the user, while viewing the scenery (view) in front of the vehicle during driving, shifts their line of sight (gaze) in the order of the first virtual image, the second virtual image, and the forward view, the focusing of the line of sight shifts from near to far, making it easier to focus. This can reduce the user's burden when viewing different virtual images.

(2) In the display system according to (1), a distance between the first virtual image and the second virtual image in a side view of the vehicle may be within 0.25 diopters.

In the display system according to (2), since the distance between the first virtual image and the second virtual image in a side view of the vehicle is within 0.25 diopters, the amount of focusing (amount of eye focus adjustment) when the user shifts their line of sight from the first virtual image to the second virtual image can be further reduced.

(3) In the display system according to (1) or (2), the first virtual image and the second virtual image may be positioned lower than a viewpoint of the user, and a depression angle of the second virtual image may be greater than a depression angle of the first virtual image, and the first virtual image and the second virtual image may be at a same position in a front-rear direction of the vehicle.

In the display system according to (3), since the first virtual image and the second virtual image are at the same position in the front-rear direction of the vehicle, the movement of the user's line of sight when shifting from the first virtual image to the second virtual image can be facilitated.

(4) In the display system according to any one of (1) to (3), the second display device may include instrument information in the second virtual image.

In the display system according to (4), in the case where the second virtual image includes the instrument information, focusing when the user shifts their line of sight in the order of the first virtual image, the second virtual image, and the forward view can be facilitated.

(5) In the display system according to any one of (1) to (4), the second display device may include a side rear image of the vehicle in the second virtual image.

In the display system according to (5), in the case where the second virtual image includes the side rear image of the vehicle, focusing when the user shifts their line of sight in the order of the first virtual image, the second virtual image, and the forward view can be facilitated.

(6) In the display system according to any one of (1) to (5), the second display device may include a wide-angle image of a front or rear of the vehicle in the second virtual image.

In the display system according to (6), in the case where the second virtual image includes the wide-angle image of the front or rear of the vehicle, focusing when the user shifts their line of sight in the order of the first virtual image, the second virtual image, and the forward view can be facilitated.

(7) In the display system according to any one of (1) to (6), the second display device may include, in the second virtual image, a blind spot image of a blind spot caused by a pillar of the vehicle.

In the display system according to (7), since the blind spot image of the blind spot caused by the pillar of the vehicle is included in the second virtual image by the second display device, the blind spot image can be displayed at a lower cost than when the pillar itself is equipped with a display.

(8) In the display system according to any one of (1) to (7), the first display device may be a combiner-type head-up display.

In the display system according to (8), in the case where the first display device is a combiner-type head-up display, focusing when the user shifts their line of sight in the order of the first virtual image, the second virtual image, and the forward view can be facilitated.

(9) The display system according to any one of (1) to (8) may include: an imager that captures surroundings of the vehicle; a first detector that detects an object around the vehicle; and a controller that controls the first display device and the second display device, when the first detector detects the object, the controller may cause the second display device to project the second virtual image including the object captured by the imager, and cause the first display device and the second display device to project the first virtual image and the second virtual image including a guidance mark for guiding a line of sight of the user to the object in the second virtual image, and the guidance mark may be projected to gradually move from the first virtual image toward the object in the second virtual image and gradually decrease in size.

In the display system according to (9), when the first detector detects the object, the guidance mark is projected so as to gradually move from the first virtual image toward the object in the second virtual image and gradually decrease in size. Thus, the user's line of sight can be guided from the first virtual image to the object in the second virtual image.

(10) In the display system according to (9), the controller may cause the first display device to project the first virtual image including a warning mark together with the guidance mark, and the warning mark may be removed after the guidance mark moves to the object in the second virtual image.

In the display system according to (10), when the first detector detects the object, the first virtual image includes the warning mark together with the guidance mark, so that the user is notified by the guidance mark and the warning mark that the object around the vehicle has been detected. Hence, the user can recognize the object more quickly. Moreover, since the warning mark is removed once the guidance mark has moved to the object in the second virtual image, excessive projection of the warning mark can be suppressed.

(11) In the display system according to (9) or (10), the controller may cause the second display device to project the second virtual image including a frame image at an outer periphery of the second virtual image including the object.

In the display system according to (11), since the second virtual image including the object and the frame image is projected, the user can quickly recognize that the second virtual image includes the object by viewing the frame image.

(12) In the display system according to (11), the controller may cause the first display device to project the first virtual image including part of the frame image.

In the display system according to (12), since the first virtual image includes part of the frame image, the display area of the frame image is expanded. The frame image with the expanded display area is more noticeable to the user. Therefore, the user can more quickly recognize that the second virtual image includes the object.

(13) The display system according to any one of (1) to (8) may include: an imager that captures surroundings of the vehicle; a first detector that detects an object around the vehicle; and a controller that controls the first display device and the second display device, and when the first detector detects the object, the controller may cause the second display device to project the second virtual image including the object captured by the imager, and cause the first display device and the second display device to project the first virtual image and the second virtual image including a radial mark originating from the object in the second virtual image.

In the display system according to (13), when the first detector detects the object, the first virtual image and the second virtual image include the radial mark originating from the object in the second virtual image. With the radial mark, the user's line of sight can be guided from the first virtual image to the object in the second virtual image.

(14) The display system according to any one of (1) to (8) may include: an imager that captures surroundings of the vehicle; a first detector that detects an object around the vehicle; and a controller that controls the first display device and the second display device, and when the first detector detects the object, the controller may cause the second display device to project the second virtual image including the object captured by the imager, and cause the first display device to project the first virtual image including a guidance mark for guiding a line of sight of the user to the second virtual image.

In the display system according to (14), when the first detector detects the object, the second virtual image including the object and the first virtual image including the guidance mark are projected. Thus, the user's line of sight can be guided from the first virtual image to the second virtual image.

(15) In the display system according to (14), the controller may cause the second display device to project the second virtual image including a frame image at an outer periphery of the second virtual image including the object.

In the display system according to (15), since the second virtual image including the object and the frame image is projected, the user can quickly recognize that the second virtual image includes the object by viewing the frame image.

(16) The display system according to any one of (1) to (8) may include: an imager that captures surroundings of the vehicle; a first detector that detects an object around the vehicle; and a controller that controls the first display device and the second display device, when the first detector detects the object, the controller may cause the second display device to project the second virtual image including the object captured by the imager, and cause the first display device and the second display device to project the first virtual image and the second virtual image including a guidance mark for guiding a line of sight of the user to the object in the second virtual image, and the guidance mark may be projected to move from an edge part of the first virtual image toward a center of the first virtual image and thereafter move toward the object in the second virtual image.

In the display system according to (16), when the first detector detects the object, the guidance mark is projected so as to move from the edge part of the first virtual image toward the center of the first virtual image and then move toward the object in the second virtual image. Thus, the user's line of sight can be guided from the first virtual image to the object in the second virtual image.

(17) The display system according to any one of (1) to (8) may include: an imager that captures surroundings of the vehicle; a first detector that detects an object around the vehicle; a second detector that detects a line of sight of the user; and a controller that controls the first display device and the second display device, and when the first detector detects the object, the controller may cause the second display device to project the second virtual image including the object captured by the imager, and cause the first display device to project the first virtual image including a warning mark at a position corresponding to the line of sight of the user detected by the second detector.

In the display system according to (17), when the first detector detects the object, the second virtual image including the object and the first virtual image including the warning mark at the position corresponding to the user's line of sight are projected. Therefore, the user can quickly recognize that the second virtual image includes the object by viewing the warning mark.

(18) The display system according to any one of (1) to (8) may include: an imager that captures surroundings of the vehicle; a first detector that detects an object around the vehicle; an alerter that outputs at least one of a warning sound or a warning vibration to the user; and a controller that controls the first display device, the second display device, and the alerter, and when the first detector detects the object, the controller may cause the alerter to output at least one of the warning sound or the warning vibration, and thereafter cause the second display device to project the second virtual image including the object captured by the imager.

In the display system according to (18), when the first detector detects the object, at least one of the warning sound or the warning vibration is output by the alerter and then the second virtual image including the object is projected. Therefore, the user can quickly recognize that the second virtual image includes the object by perceiving at least one of the warning sound or the warning vibration.

### EMBODIMENTS

Embodiments will be described in detail below with reference to the drawings. The embodiments described below each show a specific example according to the present disclosure. The numerical values, shapes, materials, structural elements, the arrangement and connection of the structural elements, steps, the processing order of the steps etc. shown in the following embodiments are mere examples, and do not limit the scope of the present disclosure. Of the structural elements in the following embodiments, the structural elements not recited in any one of the independent claims representing the broadest concepts will be described as optional structural elements.

In the following embodiments, expressions indicating the relationship between two directions, such as “parallel” and “orthogonal,” may be used. These expressions also include cases where the directions are not strictly in the indicated relationship. For example, the expression “two directions are parallel” means not only the two directions are perfectly parallel but also the two directions are substantially parallel, allowing for a difference of several percent, unless otherwise specified. The optical paths depicted in the drawings of the following embodiments are illustrative of basic principles and do not necessarily correspond to actual optical paths.

### Embodiment 1

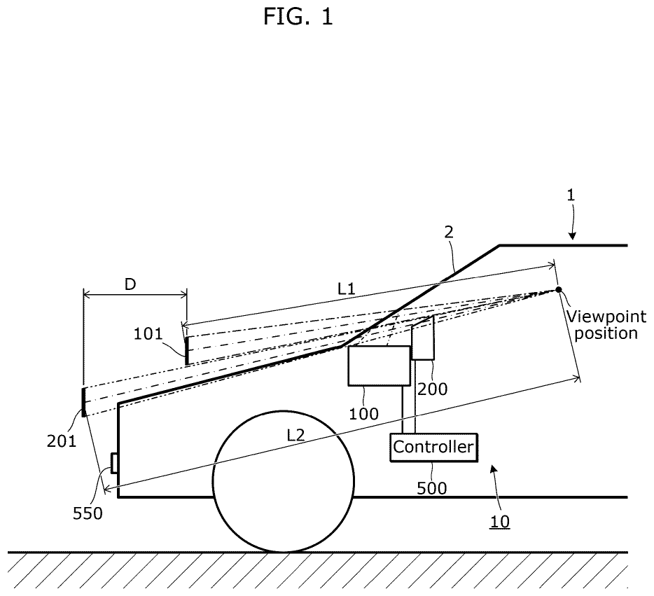

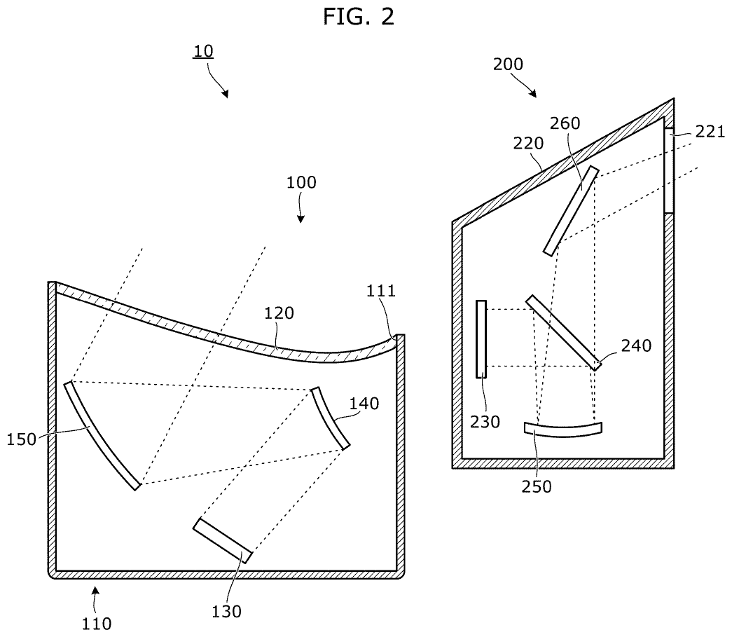

FIG. 1 is a schematic diagram illustrating a state in which display system 10 according to Embodiment 1 is provided in vehicle 1. In FIG. 1, vehicle 1 is illustrated in cross-section. FIG. 2 is a schematic diagram illustrating first display device 100 and second display device 200 included in display system 10 according to Embodiment 1.

As illustrated in FIGS. 1 and 2, display system 10 includes first display device 100, second display device 200, and controller 500. First display device 100 and second display device 200 are disposed within a dashboard of vehicle 1, and project, for example, vehicle information related to vehicle 1 as first virtual image 101 and second virtual image 201 respectively. Examples of the vehicle information include the vehicle speed of vehicle 1, engine revolutions per minute (RPM), a detection result of an object near vehicle 1, and navigation information from the current location of vehicle 1 to a destination.

### <First Display Device>

First display device 100 is an augmented reality head-up display (AR-HUD). First display device 100 projects image light onto windshield 2 of vehicle 1. The projected image light is reflected by windshield 2. The reflected light travels toward the eyes of a driver seated in the driver's seat as a user.

The driver perceives the reflected light entering their eyes as first virtual image 101 appearing on the opposite side of windshield 2 (i.e. outside the vehicle), with actual objects seen through windshield 2 as the background. In this way, first display device 100 projects a virtual image in front of the driver aboard vehicle 1.

As illustrated in FIG. 2, first display device 100 includes housing 110, cover portion 120, display element 130, first optical element 140, and second optical element 150.

Housing 110 is a box-shaped body formed of light-shielding resin or metal. Specifically, housing 110 has a substantially rectangular parallelepiped shape, and has opening 111 at the top. Opening 111 is covered by cover portion 120. Display element 130, first optical element 140, and second optical element 150 are contained in the internal space formed by housing 110 and cover portion 120.

Cover portion 120 is a curved plate body formed of translucent resin or glass, for example. Specifically, cover portion 120 has a convex downward shape as a whole.

Display element 130 is, for example, a liquid crystal panel. When irradiated with light from a light source (not illustrated), display element 130 displays an image serving as the basis of first virtual image 101 and emits image light of the image toward first optical element 140. Display element 130 may be an organic electroluminescent (EL) panel. Display element 130 has a rectangular shape in a plan view, and is inclined with respect to a horizontal plane.

First optical element 140 is an optical element that is disposed on the optical path of the image light emitted from display element 130 and reflects the image light toward second optical element 150. First optical element 140 is a convex mirror with a rectangular shape in a plan view. First optical element 140 is inclined with respect to a vertical plane of housing 110. The reflective surface of first optical element 140 faces display element 130 and second optical element 150. In detail, first optical element 140 is positioned so that the reflective surface, which is the mirror surface of the convex mirror, will face the inside of housing 110 (i.e. inward) and the concave surface will face the outside of housing 110 (i.e. outward).

Second optical element 150 is disposed on the optical path of the image light having passed through first optical element 140, and reflects the image light reflected by first optical element 140 toward opening 111. Specifically, second optical element 150 is a concave mirror with a rectangular shape in a plan view. Second optical element 150 faces the reflective surface side of first optical element 140, and is inclined with respect to the vertical plane of housing 110. The reflective surface of second optical element 150 faces first optical element 140 and cover portion 120. In detail, second optical element 150 is positioned so that the reflective surface, which is the mirror surface of the concave mirror, will face the inside of housing 110 (i.e. inward) and the convex surface will face the outside of housing 110 (i.e. outward). The image light reflected by second optical element 150 is projected onto windshield 2 via opening 111. By this reflection, the image light travels toward the eyes of the driver seated in the driver's seat, and forms first virtual image 101. The position of first virtual image 101 as seen from the driver's viewpoint is illustrated in FIG. 1. This position can be set by adjusting the viewing distance of the image light emitted from display element 130 in first display device 100. The viewing distance is the distance from the driver's viewpoint position to the image formation position of the virtual image (for example, first virtual image 101). The driver's viewpoint position is, for example, a reference eye point. The reference eye point is a point representing the position of the driver's eyes under normal driving conditions.

### <Second Display Device>

Second display device 200 projects image light toward the driver, as illustrated in FIG. 1. The driver perceives the image light entering their eyes as second virtual image 201 appearing at a distance beyond opening 221 (see FIG. 2) of second display device 200. Thus, second display device 200 is an example of the second display device that projects a virtual image in front of the driver. Specifically, second display device 200 projects second virtual image 201 in front of the driver and below first virtual image 101. Accordingly, the depression angle of the driver's line of sight toward second virtual image 201 is greater than the depression angle of the driver's line of sight toward first virtual image 101.

As illustrated in FIG. 2, second display device 200 includes housing 220, display element 230, polarization half mirror 240, first reflection mirror 250, and second reflection mirror 260.

Housing 220 is a box-shaped body formed of light-shielding resin or metal. At an upper end of a rear part of housing 220 (the right direction in FIG. 2 is defined as rearward), opening 221 facing rearward is formed. Image light forming second virtual image 201 is projected from opening 221. Display element 230, polarization half mirror 240, first reflection mirror 250, and second reflection mirror 260 are contained in the internal space of housing 220.

Display element 230 is, for example, a liquid crystal panel. When irradiated with light from a light source (not illustrated), display element 230 displays an image serving as the basis of second virtual image 201 and emits image light of the image toward polarization half mirror 240. Display element 230 may be an organic EL panel. Display element 230 has its display surface facing rearward. A λ/4 phase difference plate (hereinafter abbreviated as “λ/4 plate”) is laminated on the display surface of display element 230, although not illustrated. The λ/4 plate is a λ/4 phase difference plate that gives a phase difference of 1/4 of wavelength λ to light incident thereon. For example, when light emitted from the display surface is S-linearly polarized light, the light is converted into circularly polarized light by passing through the λ/4 plate.

Polarization half mirror 240 has a structure of reflecting P-polarized light and transmitting S-polarized light, and includes a reflective polarizer disposed on a flat glass substrate. A λ/4 plate is laminated on the surface of polarization half mirror 240. Polarization half mirror 240 faces display element 230 and first reflection mirror 250. Image light of S-polarized light emitted from display element 230 is converted into circularly polarized light by the λ/4 plate laminated on display element 230 and travels toward polarization half mirror 240. This circularly polarized image light is converted into P-polarized light by the λ/4 plate laminated on polarization half mirror 240 and is reflected by the reflective polarizer of polarization half mirror 240. The reflected P-polarized image light is again converted into circularly polarized light by passing through the λ/4 plate. Therefore, polarization half mirror 240 is positioned so that circularly polarized image light incident thereon will be reflected as circularly polarized light toward first reflection mirror 250 by the λ/4 plate laminated on polarization half mirror 240 and the reflective polarizer.

First reflection mirror 250 is a concave mirror and is disposed below polarization half mirror 240 in FIG. 2. First reflection mirror 250 has its concave surface as a reflective surface facing upward. The circularly polarized image light reflected by polarization half mirror 240 is reflected by first reflection mirror 250 while remaining circularly polarized, and again travels toward polarization half mirror 240. The image light incident on polarization half mirror 240 is converted into S-polarized light by the λ/4 plate laminated on polarization half mirror 240, and passes through the reflective polarizer of polarization half mirror 240 to travel upward in FIG. 2.

Second reflection mirror 260 is a flat mirror and is disposed above polarization half mirror 240. The image light traveling upward after passing through polarization half mirror 240 is thus reflected by second reflection mirror 260. Second reflection mirror 260 is positioned to reflect the image light toward opening 221. The image light reflected by second reflection mirror 260 travels toward the eyes of the driver seated in the driver's seat via opening 221 and forms second virtual image 201.

### <Controller>

Controller 500 is electrically connected to first display device 100 and second display device 200 to control them, as illustrated in FIG. 1. Specifically, controller 500 includes a CPU, a RAM, a ROM, and the like, and performs each process by the CPU developing a program stored in the ROM into the RAM and executing the program.

Controller 500 is communicably connected to imager 550 wirelessly or by wire. Imager 550 is included in vehicle 1 to capture images of the surroundings of vehicle 1. Imager 550 may be included in display system 10.

Imager 550 includes a front camera that captures an image of the front of vehicle 1, a rear camera that captures an image of the rear of vehicle 1, a right rear camera that captures an image of the right rear of vehicle 1, a left rear camera that captures an image of the left rear of vehicle 1, a right side camera that captures an image of the right side of vehicle 1, and a left side camera that captures an image of the left side of vehicle 1. The front camera as an example of imager 550 is illustrated in FIG. 1. An image captured by the front camera is included in front images. An image captured by the rear camera (rear image), an image captured by the right rear camera (right rear image), and an image captured by the left rear camera (left rear image) are all included in rear images indicating the rear of vehicle 1. An image captured by the right side camera (right side image) and an image captured by the left side camera (left side image) are all included in side images indicating the side of vehicle 1.

Controller 500 controls second display device 200 to display at least part of a front image, rear image, and side image within second virtual image 201.

Controller 500 also controls first display device 100 to display the vehicle speed of vehicle 1, navigation information, and the like within first virtual image 101. The navigation information includes an arrow for guiding the driver in the direction of travel and a warning mark indicating the occurrence of a warning object.

### <Positional Relationship Between First Virtual Image and Second Virtual Image>

The positional relationship between first virtual image 101 and second virtual image 201 will be described below. As illustrated in FIG. 1, first virtual image 101 and second virtual image 201 are each arranged in the up-down (vertical) direction. First virtual image 101 is located rearward from second virtual image 201. First viewing distance L1, which is the viewing distance from the driver's viewpoint position to first virtual image 101, is less than second viewing distance L2, which is the viewing distance from the driver's viewpoint position to second virtual image 201. Although the reference point for measuring each of the viewing distances of first virtual image 101 and second virtual image 201 is the midpoint in a side view of vehicle 1 in FIG. 1, another point (for example, the upper or lower end) may be used as the reference point as long as the reference point is the same in both virtual images.

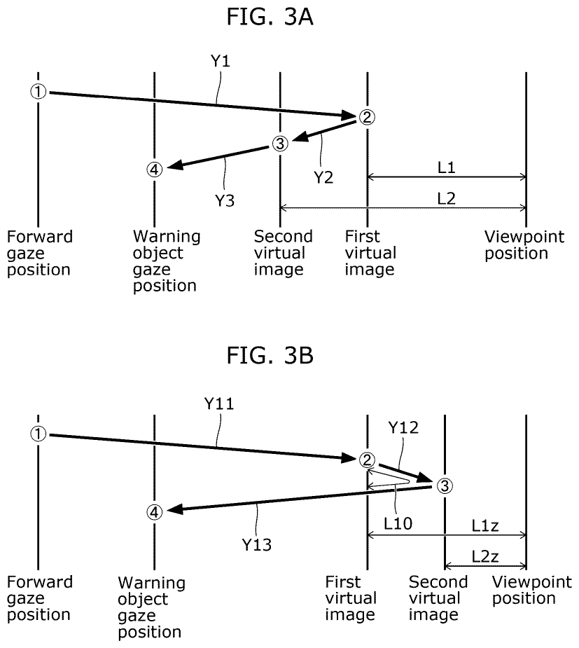

FIGS. 3A and 3B are explanatory diagrams illustrating the movement of the driver's line of sight for first virtual image 101 and second virtual image 201 according to Embodiment 1 and a comparative example, respectively. FIG. 3A illustrates line-of-sight movement according to Embodiment 1, and FIG. 3B illustrates line-of-sight movement according to the comparative example. In the comparative example, first viewing distance L1z of first virtual image 101 is equal to first viewing distance L1 in Embodiment 1, but second viewing distance L2z of second virtual image 201 is less than first viewing distance L1z unlike in Embodiment 1.

For example, suppose a warning mark is displayed to the driver in first virtual image 101 and a warning object is displayed as an image in second virtual image 201 during driving. Specifically, if the warning mark is displayed in first virtual image 101 when the driver is viewing a forward gaze position (“1” in FIG. 3A), the driver moves the line of sight rearward by line-of-sight movement Y1 and adjusts focus to view the warning mark in first virtual image 101 (“2” in FIG. 3A). After this, to identify the warning object, the driver moves the line of sight forward by line-of-sight movement Y2 and adjusts focus to view the image in second virtual image 201, thus recognizing the warning object (“3” in FIG. 3A). The driver then moves the line of sight forward by line-of-sight movement Y3 and adjusts focus to direct the line of sight to the actual warning object, thus perceiving the warning object (“4” in FIG. 3A). It is commonly considered that focusing from near to far takes less time than focusing from far to near, for the following reason. Focusing from far to near requires contraction of the ciliary muscle to thicken the crystalline lens. Meanwhile, focusing from near to far only requires relaxation of the ciliary muscle to flatten the crystalline lens, and thus can be done relatively quickly. In the above case, after adjusting focus to near to view first virtual image 101 closer to the driver, the driver gradually moves the line of sight forward so that the focal point of the eyes will shift to a farther distance. Accordingly, the driver is required to focus on a near point, where focusing is relatively difficult, only once, and thereafter only needs to focus on far points, where focusing is relatively easy. Smooth and easy line-of-sight movement is thus possible.

In the comparative example, if the warning mark is displayed in first virtual image 101 when the driver is viewing a forward gaze position (“1” in FIG. 3B), the driver moves the line of sight rearward by line-of-sight movement Y11 and adjusts focus to view the warning mark in first virtual image 101 (“2” in FIG. 3B). After this, to identify the warning object, the driver moves the line of sight further rearward by line-of-sight movement Y12 and adjusts focus to view the image in second virtual image 201, thus recognizing the warning object (“3” in FIG. 3B). The driver then moves the line of sight forward by line-of-sight movement Y13 and adjusts focus to direct the line of sight to the actual warning object, thus perceiving the warning object (“4” in FIG. 3B). In this case, after viewing first virtual image 101, the driver moves the line of sight further rearward and then moves the line of sight forward. Thus, the driver needs to move the line of sight rearward and adjust focus twice. This can be burdensome to the driver, particularly when the driver is an elderly person with presbyopia. When a presbyopic driver moves the line of sight rearward (i.e. to a near point) and adjusts focus, their vision may remain blurred. Moreover, when the presbyopic driver moves the line of sight toward the warning object from this state, smooth line-of-sight movement may be disrupted or proper focus may not be achieved.

In this embodiment, the driver moves the line of sight rearward (i.e. to a near point) and adjusts focus only once, and then gradually moves the line of sight forward. Therefore, the driver can easily focus on second virtual image 201 and the warning object gaze position. In addition, the total length of line-of-sight movement in this embodiment is shorter by about length L10 in FIG. 3B than in the comparative example. The driver's burden can be reduced from this perspective, too.

Distance D between first virtual image 101 and second virtual image 201 in a side view of vehicle 1 as illustrated in FIG. 1 is preferably within 0.25 diopters. Here, “diopter” is defined as the absolute value of the difference between the reciprocal of the distance from the viewpoint position to first virtual image 101 and the reciprocal of the distance from the viewpoint position to second virtual image 201. As a result of the distance between first virtual image 101 and second virtual image 201 being within 0.25 diopters, the amount of focusing when the driver shifts the line of sight from first virtual image 101 to second virtual image 201 can be further reduced.

### <Display Examples of Second Virtual Image>

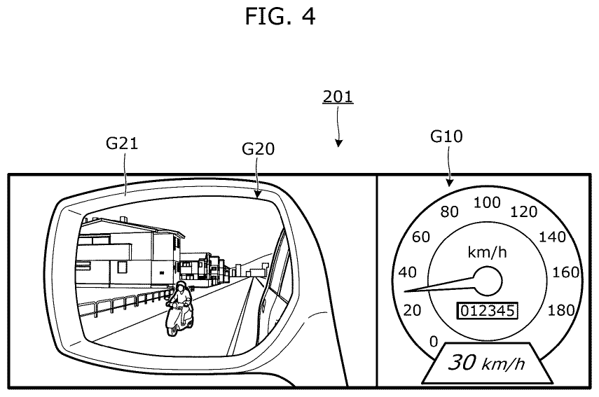

Next, display examples of second virtual image 201 will be described. FIG. 4 is an explanatory diagram illustrating a first display example of second virtual image 201 according to Embodiment 1. As illustrated in FIG. 4, second virtual image 201 includes instrument information G10 on the right side and left rear image G20 among side rear images on the left side. Instrument information G10 is information measured by instruments included in vehicle 1, and includes, for example, measured values from a speedometer, a tachometer, and an external temperature gauge. Left rear image G20 is an image of the left rear of vehicle 1 captured by the left rear camera, and is displayed based on the operation of a turn signal control or the detection result of a vehicle exterior camera. In the image illustrated in FIG. 4, left rear image G20 is shown within side mirror frame G21. Second virtual image 201 may include a front image and a side image.

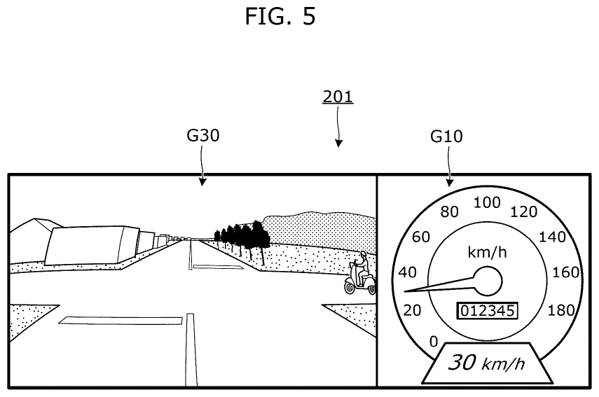

FIG. 5 is an explanatory diagram illustrating a second display example of second virtual image 201 according to Embodiment 1. As illustrated in FIG. 5, second virtual image 201 includes instrument information G10 on the right side and front image G30 of vehicle 1 captured by the front camera on the left side. Front image G30 is displayed based on vehicle speed information or the detection result of the front camera. If the front camera is a wide-angle camera, front image G30 is included as a wide-angle image in second virtual image 201. Second virtual image 201 may include a wide-angle rear image.

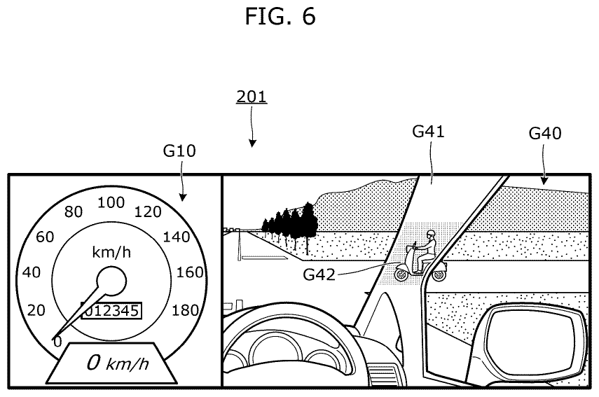

FIG. 6 is an explanatory diagram illustrating a third display example of second virtual image 201 according to Embodiment 1. As illustrated in FIG. 6, second virtual image 201 includes instrument information G10 on the left side and blind spot image G40 on the right side. Blind spot image G40 is an image indicating a view of the driver's blind spot caused by a pillar of vehicle 1. In FIG. 6, blind spot image G40 is located on the right side so as to correspond to a right pillar of vehicle 1. For a left pillar of vehicle 1, blind spot image G40 may be located on the left side.

Vehicle 1 is further provided with a vehicle interior camera that captures the vehicle interior and a blind spot camera that captures outside images of blind spots caused by pillars. Blind spot image G40 is displayed as a composite image of interior image G41 captured by the vehicle interior camera and outside image G42 captured by the blind spot camera. When the vehicle interior camera is provided, controller 500 may estimate the viewpoint position of the driver from the image captured by the vehicle interior camera and composite interior image G41 and outside image G42 so as to correspond to the viewpoint position.

Vehicle 1 may be provided with a warning object sensor for detecting a warning object (motorcycle, bicycle, person, etc.) outside the vehicle. In this case, when the warning object sensor detects a warning object at a position that is a blind spot caused by a pillar, controller 500 includes blind spot image G40 in second virtual image 201 and projects second virtual image 201.

### <Effects, Etc.>

As described above, according to this embodiment, first viewing distance L1 from the driver to first virtual image 101 is less than second viewing distance L2 from the driver to second virtual image 201. As a result, when the driver, while viewing the scenery (view) in front of vehicle 1 during driving, shifts their line of sight in the order of first virtual image 101, second virtual image 201, and the forward view, the focusing of the driver's line of sight shifts from near to far, making it easier to focus. This can reduce the driver's burden when viewing different virtual images.

Moreover, since distance D between first virtual image 101 and second virtual image 201 in a side view of vehicle 1 is within 0.25 diopters, the amount of focusing of the line of sight when the driver shifts their line of sight from first virtual image 101 to second virtual image 201 can be further reduced.

Moreover, in the case where second virtual image 201 includes instrument information G10, focusing when the user shifts their line of sight in the order of first virtual image 101, second virtual image 201, and the forward view can be facilitated.

Moreover, in the case where second virtual image 201 includes the side rear image of vehicle 1, focusing when the user shifts their line of sight in the order of first virtual image 101, second virtual image 201, and the forward view can be facilitated.

Moreover, in the case where second virtual image 201 includes the wide-angle image of the front or rear of vehicle 1, focusing when the user shifts their line of sight in the order of first virtual image 101, second virtual image 201, and the forward view can be facilitated.

Moreover, since blind spot image G40 of the blind spot caused by the pillar of vehicle 1 is included in second virtual image 201, blind spot image G40 can be displayed at a lower cost than when the pillar itself is equipped with a display.

### Embodiment 2

In the following description, components that are the same as those in Embodiment 1 and other embodiments will be given the same reference signs and their description may be omitted. Embodiment 1 describes an example in which first display device 100 that projects first virtual image 101 is an AR-HUD. Alternatively, the first virtual image may be projected by an electronic mirror-type display device.

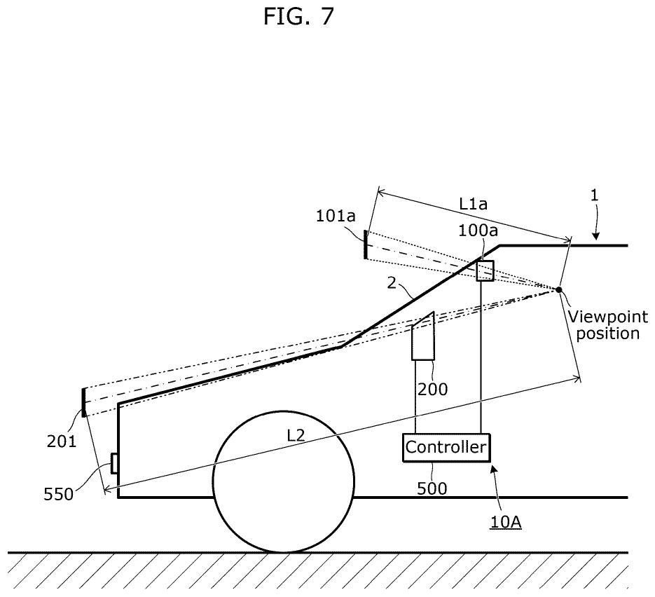

FIG. 7 is a schematic diagram illustrating a state in which display system 10A according to Embodiment 2 is provided in vehicle 1. FIG. 7 corresponds to FIG. 1. As illustrated in FIG. 7, display system 10A according to Embodiment 2 projects first virtual image 101a by electronic mirror-type display device 100a.

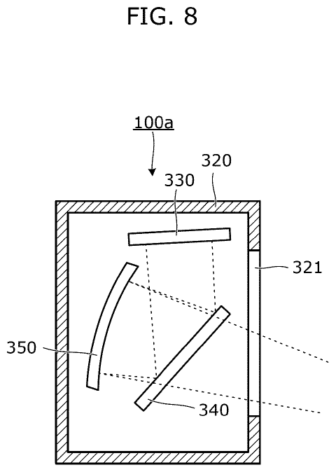

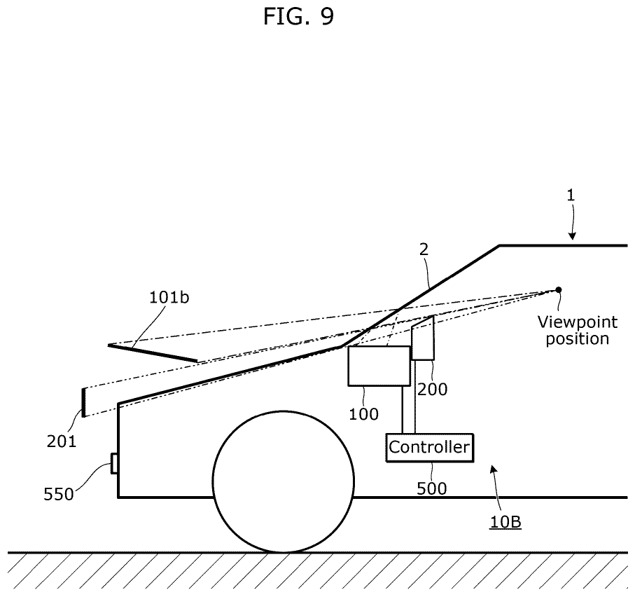

Specifically, electronic mirror-type display device 100a is disposed at the upper center of windshield 2 within the vehicle interior. Display system 10A includes a rear camera (not illustrated) that captures the rear of vehicle 1. Electronic mirror-type display device 100a projects first virtual image 101a based on a rear image obtained by the rear camera. Electronic mirror-type display device 100a projects image light toward the driver. The driver perceives the image light entering the eyes as first virtual image 101a appearing at a distance beyond opening 321 (see FIG. 8) of electronic mirror-type display device 100a. Thus, electronic mirror-type display device 100a is an example of the first display device that projects a virtual image in front of the driver. Specifically, electronic mirror-type display device 100a projects first virtual image 101a in front of the driver and above second virtual image 201.

FIG. 8 is a schematic diagram illustrating electronic mirror-type display device 100a according to Embodiment 2. As illustrated in FIG. 8, electronic mirror-type display device 100a includes housing 320, display element 330, polarization half mirror 340, and concave mirror 350.

Housing 320 is a box-shaped body formed of light-shielding resin or metal. At a rear part of housing 320 (the right direction in FIG. 8 is defined as rearward), opening 321 facing rearward is formed. Image light forming first virtual image 101a is projected from opening 321. Display element 330, polarization half mirror 340, and concave mirror 350 are contained in the internal space of housing 320. Display element 330 is controlled by controller 500.

Display element 330 is, for example, a liquid crystal panel. When irradiated with light from a light source (not illustrated), display element 330 displays an image serving as the basis of first virtual image 101a and emits image light of the image toward polarization half mirror 340. Display element 330 may be an organic EL panel. Display element 330 has its display surface facing downward. A λ/4 plate is laminated on the display surface of display element 330, although not illustrated. The λ/4 plate is a λ/4 phase difference plate that gives a phase difference of 1/4 of wavelength λ to light incident thereon. For example, when light emitted from the display surface is S-linearly polarized light, the light is converted into circularly polarized light by passing through the λ/4 plate.

Polarization half mirror 340 has a structure of reflecting P-polarized light and transmitting S-polarized light, and includes a reflective polarizer disposed on a flat glass substrate. A λ/4 plate is laminated on the surface of polarization half mirror 340. Polarization half mirror 340 faces display element 330 and concave mirror 350. Image light of S-polarized light emitted from display element 330 is converted into circularly polarized light by the λ/4 plate laminated on display element 330 and travels toward polarization half mirror 340. The circularly polarized image light is converted into P-polarized light by the λ/4 plate laminated on polarization half mirror 340 and is reflected by the reflective polarizer of polarization half mirror 340. The reflected P-polarized image light is again converted into circularly polarized light by passing through the λ/4 plate. Therefore, polarization half mirror 340 is positioned so that circularly polarized image light incident thereon will be reflected as circularly polarized light toward concave mirror 350 by the λ/4 plate laminated on polarization half mirror 340 and the reflective polarizer.

Concave mirror 350 is disposed in front of polarization half mirror 340. Concave mirror 350 has its concave surface as a reflective surface facing rearward. The circularly polarized image light reflected by polarization half mirror 340 is reflected by concave mirror 350 while remaining circularly polarized, and again travels toward polarization half mirror 340. The image light incident on polarization half mirror 340 is converted into S-polarized light by the λ/4 plate laminated on polarization half mirror 340, and passes through the reflective polarizer of polarization half mirror 340 to travel rearward in FIG. 8. The image light travels toward the eyes of the driver seated in the driver's seat via opening 321 and forms first virtual image 101a.

As described above, when electronic mirror-type display device 100a is provided as an example of the first display device, too, first viewing distance L1a from the driver to first virtual image 101a is less than second viewing distance L2 from the driver to second virtual image 201. As a result, when the driver, while viewing the scenery (view) in front of vehicle 1 during driving, shifts their line of sight in the order of first virtual image 101a, second virtual image 201, and the forward view, the focusing of the driver's line of sight shifts from near to far, making it easier to focus. This can reduce the driver's burden when viewing different virtual images.

### Embodiment 3

Embodiment 1 describes an example in which first viewing distance L1 is less than second viewing distance L2 and first virtual image 101 is located rearward from second virtual image 201 in a side view. As another example, in addition to first viewing distance L1 being less than second viewing distance L2, first virtual image 101 and second virtual image 201 are positioned lower than the driver's viewpoint and the depression angle of second virtual image 201 is greater than the depression angle of first virtual image 101 as illustrated in FIG. 1, and first virtual image 101 and second virtual image 201 are at the same position in the front-rear direction of vehicle 1. In this case, since first virtual image 101 and second virtual image 201 are positioned lower than the driver's viewpoint and first virtual image 101 is positioned higher than second virtual image 201, first viewing distance L1 from the driver's viewpoint to first virtual image 101 is less than second viewing distance L2 from the driver's viewpoint to second virtual image 201.

Thus, since first virtual image 101 and second virtual image 201 are at the same position in the front-rear direction of vehicle 1, the movement of the line of sight when shifting in the order of first virtual image 101, second virtual image 201, and the forward view can be facilitated.

### Embodiment 4

FIG. 9 is a schematic diagram illustrating a state in which display system 10B according to Embodiment 4 is provided in vehicle 1. FIG. 9 corresponds to FIG. 1. Embodiment 1 describes an example in which first virtual image 101 and second virtual image 201 are each arranged in the up-down direction. In display system 10B according to Embodiment 4, the viewing distance to the lower end of first virtual image 101b is less than the viewing distance to the upper end of first virtual image 101b, as illustrated in FIG. 9. In this case, the viewing distance to the upper end of first virtual image 101b may be less than the viewing distance to second virtual image 201, but the present disclosure is not limited to such as long as the viewing distance to at least part of first virtual image 101b is less than the viewing distance to second virtual image 201.

Since the viewing distance to the lower end of first virtual image 101b is less than the viewing distance to the upper end of first virtual image 101b, first virtual image 101b can provide the driver with a more natural sense of depth.

### Embodiment 5

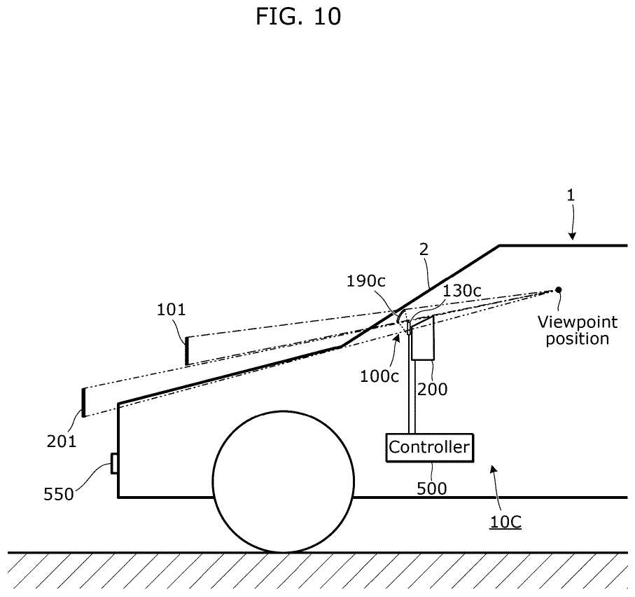

FIG. 10 is a schematic diagram illustrating a state in which display system 10C according to Embodiment 5 is provided in vehicle 1. FIG. 10 corresponds to FIG. 1. Embodiment 1 describes an example in which first display device 100 that projects first virtual image 101 is an AR-HUD. In display system 10C according to Embodiment 5, the first display device is combiner-type head-up display 100c, as illustrated in FIG. 10.

Combiner-type head-up display 100c includes display element 130c and combiner 190c. Display element 130c is installed in the dashboard of vehicle 1, and emits image light of an image serving as the basis of first virtual image 101 toward combiner 190c.

Combiner 190c is installed standing upright on the dashboard. For example, combiner 190c is a half mirror, and is composed of a plate glass and a light semi-transmissive film such as tin or silver vapor-deposited on one surface of the plate glass. Combiner 190c has semi-transmissivity, and is formed so that the driver can visually observe the front of vehicle 1 through combiner 190c. For example, combiner 190c is a convex or concave plate. The image light reflected by combiner 190c travels toward the eyes of the driver seated in the driver's seat and forms first virtual image 101.

Thus, in the case where the first display device is combiner-type head-up display 100c, too, focusing when shifting the line of sight in the order of first virtual image 101, second virtual image 201, and the forward view can be facilitated.

### Embodiment 6

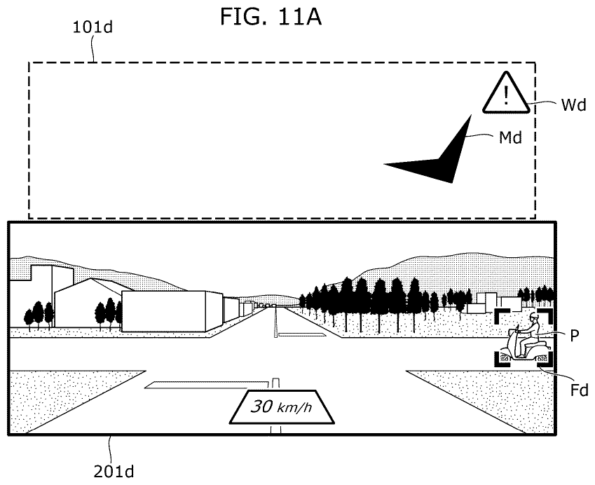

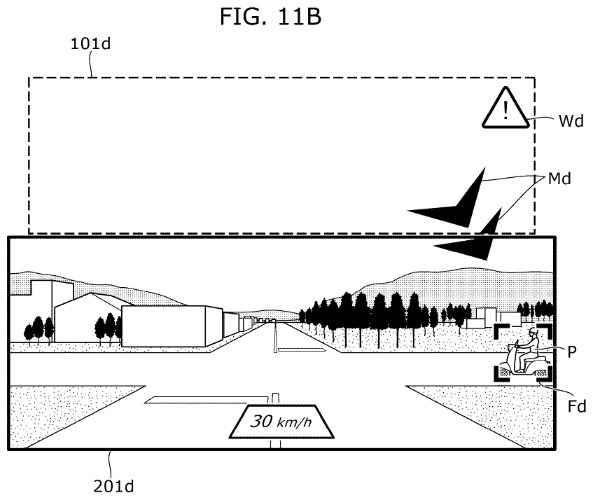

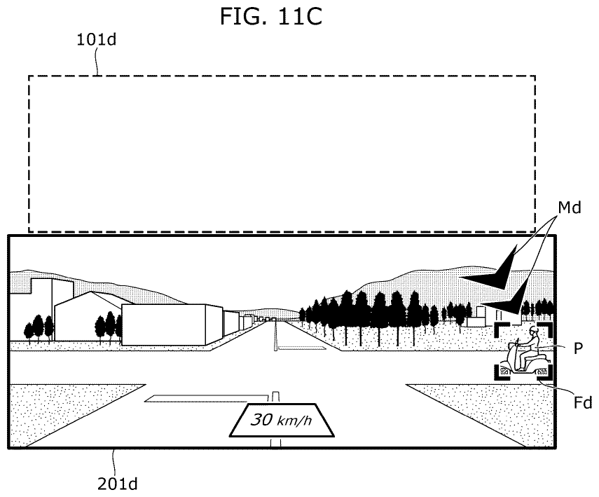

In Embodiment 6, a display example of the first virtual image and the second virtual image will be described. FIGS. 11A to 11C are explanatory diagrams illustrating a display example according to Embodiment 6.

Controller 500 detects objects around vehicle 1 by performing image processing on image data captured by imager 550. In other words, controller 500 is an example of the first detector according to the present disclosure. Here, the objects are moving bodies existing around vehicle 1 (pedestrians, animals, vehicles (automobiles, two-wheeled vehicles, kickboards, etc.) other than vehicle 1). Controller 500 may detect objects based on outputs from sensors other than imager 550. Examples of the other sensors include laser imaging, detection, and ranging (LiDAR).

When controller 500 detects an object around vehicle 1, controller 500 causes second display device 200 to project second virtual image 201d including object P captured by imager 550, and causes first display device 100 and second display device 200 to project first virtual image 101d and second virtual image 201d including guidance mark Md.

In second virtual image 201d, an image of the surroundings of vehicle 1 based on the image data captured by imager 550 is displayed. The surroundings image includes object P. In this embodiment, to highlight object P, highlight frame Fd is superimposed on the surroundings image. Highlight frame Fd is not displayed before the object around vehicle 1 is detected based on the image data.

When the object around vehicle 1 is detected, warning mark Wd and guidance mark Md are displayed in first virtual image 101d. Warning mark Wd and guidance mark Md are not displayed in first virtual image 101d before the object around vehicle 1 is detected.

Warning mark Wd is a mark for notifying the user that an object has been detected. The form of warning mark Wd is not limited as long as it can notify the user that an object has been detected. In this embodiment, warning mark Wd in first virtual image 101d is positioned above object P. The user who is unaware that object P is displayed can recognize the display of object P and its approximate display position by viewing warning mark Wd.

Guidance mark Md is a mark for guiding the user's line of sight to object P in second virtual image 201d. In this embodiment, guidance mark Md is an arrow. However, the form of guidance mark Md is not limited as long as it can guide the user's line of sight to object P. Guidance mark Md is projected so as to gradually move from first virtual image 101d toward object P in second virtual image 201d and gradually decrease in size. In this embodiment, the user's line of sight is guided from first virtual image 101d to object P in second virtual image 201d by a plurality of guidance marks Md.

Specifically, first, guidance mark Md is displayed only in first virtual image 101d as illustrated in FIG. 11A. Then, guidance mark Md is displayed in both first virtual image 101d and second virtual image 201d as illustrated in FIG. 11B. After this, guidance mark Md is displayed only in second virtual image 201d and reaches object P as illustrated in FIG. 11C. Warning mark Wd is removed upon guidance mark Md reaching object P. Thus, the plurality of guidance marks Md are displayed in an animation-like manner that gradually moves from a predetermined position in first virtual image 101d toward object P in second virtual image 201d. The plurality of guidance marks Md are also displayed in an animation-like manner that gradually decreases in size toward object P. Although the movement path of guidance mark Md is a straight line with object P as the endpoint in this embodiment, the movement path of guidance mark Md may be a curved line with object P as the endpoint.

As described above, when controller 500 detects an object, guidance mark Md is projected to gradually move from first virtual image 101d toward object P in second virtual image 201d and gradually decrease in size. Thus, the user's line of sight can be guided from first virtual image 101d to object P in second virtual image 201d.

Since first virtual image 101d is closer to the user than second virtual image 201d as mentioned above, elderly users with presbyopia may not be able to quickly and accurately recognize first virtual image 101d. In this embodiment, immediately after an object around vehicle 1 is detected, large guidance mark Md is displayed together with warning mark Wd in first virtual image 101d. Hence, elderly users can recognize that some kind of notification image is displayed in first virtual image 101d, and can at least notice that an object is approaching vehicle 1. Subsequently, the user's line of sight is guided by guidance mark Md in the order of first virtual image 101d and second virtual image 201d, so that the user can adjust focus easily.

When controller 500 detects the object, first virtual image 101d includes warning mark Wd together with guidance mark Md, so that the user is notified by guidance mark Md and warning mark Wd that the object around vehicle 1 has been detected. Hence, the user can recognize the object more quickly. Moreover, since warning mark Wd is removed once guidance mark Md has moved to object P in second virtual image 201d, excessive projection of warning mark Wd can be suppressed. As a result, the possibility that the user is confused as to whether to recognize warning mark Wd or recognize object P can be reduced.

### Embodiment 7

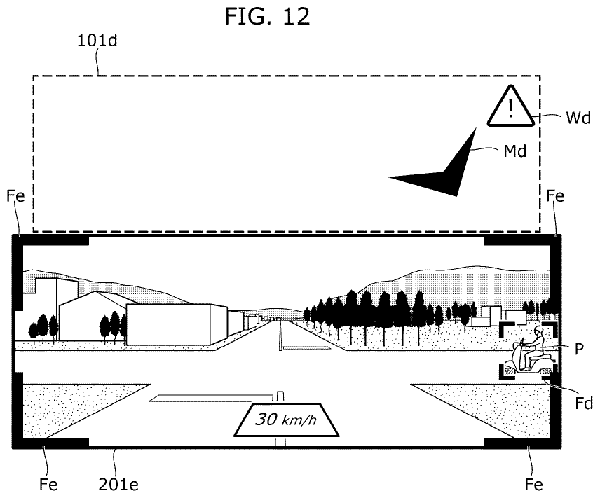

In Embodiment 7, a display example of the second virtual image will be described. FIG. 12 is an explanatory diagram illustrating a display example according to Embodiment 7. FIG. 12 corresponds to FIG. 11A.

Controller 500 causes second display device 200 to project second virtual image 201e including frame image Fe at the outer periphery of second virtual image 201e including object P. Frame image Fe may be a frame image formed on part of the outer periphery of second virtual image 201e or a frame image continuously formed on the entire outer periphery. In this embodiment, frame image Fe is formed only at the four corners of second virtual image 201e. Frame image Fe may be continuously lit or may blink. Frame image Fe may be removed upon guidance mark Md reaching object P.

Thus, since second virtual image 201e including object P and frame image Fe is projected, the user can quickly recognize that second virtual image 201e includes object P by viewing frame image Fe.

### Embodiment 8

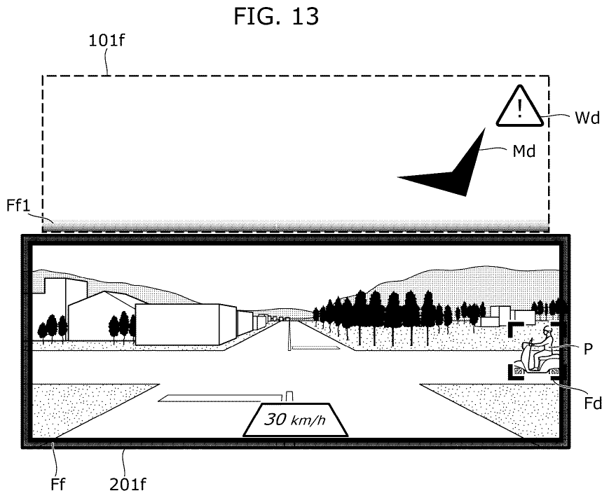

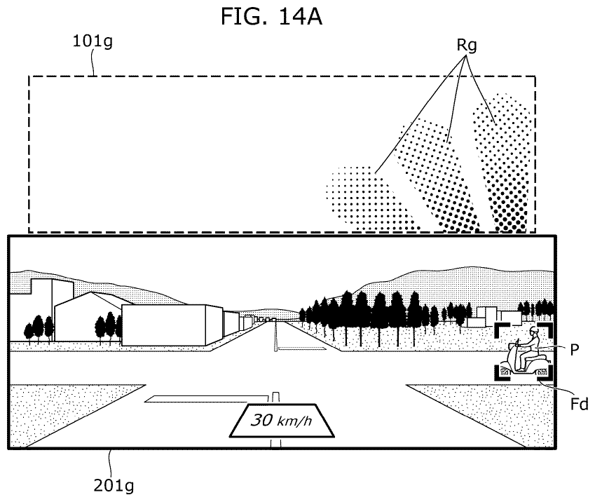

In Embodiment 8, a display example of the first virtual image and the second virtual image will be described. FIG. 13 is an explanatory diagram illustrating a display example according to Embodiment 8. FIG. 13 corresponds to FIG. 12.

Controller 500 causes first display device 100 to project first virtual image 101f including part of frame image Ff, and causes second display device 200 to project second virtual image 201f including the remaining part of frame image Ff. In this embodiment, frame image Ff continuous on the entire outer periphery of second virtual image 201f is displayed, and upper edge part Ff1 of frame image Ff is displayed on the lower edge of first virtual image 101f, as illustrated in FIG. 13. Particularly, in this embodiment, upper edge part Ff1 of frame image Ff is displayed as if bleeding into the lower edge of first virtual image 101f, although other expressions may be used.

Thus, since first virtual image 101f includes part of frame image Ff (upper edge part Ff1), the display area of frame image Ff is expanded. Frame image Ff with the expanded display area is more noticeable to the user. Therefore, the user can more quickly recognize that second virtual image 201f includes object P.

While this embodiment describes an example in which first virtual image 101f is positioned above and second virtual image 201f is positioned below, when second virtual image 201f is positioned above and first virtual image 101f is positioned below, the lower edge part of frame image Ff is displayed on the upper edge of first virtual image 101f.

### Embodiment 9

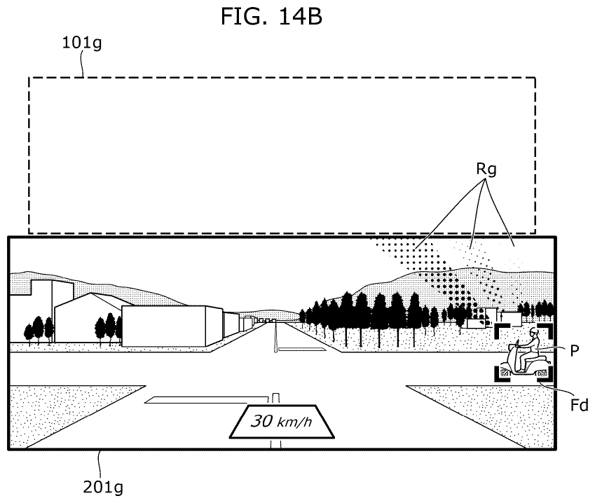

In Embodiment 9, a display example of the first virtual image and the second virtual image will be described. FIGS. 14A and 14B are explanatory diagrams illustrating a display example according to Embodiment 9.

When controller 500 detects an object around vehicle 1, controller 500 causes second display device 200 to project second virtual image 201g including object P captured by imager 550, and causes first display device 100 and second display device 200 to project first virtual image 101g and second virtual image 201g including radial mark Rg.

Radial mark Rg is a mark that spreads radially outward from object P in second virtual image 201g. In this embodiment, the user's line of sight is guided from first virtual image 101g to object P in second virtual image 201g by radial mark Rg.

Specifically, first, radial mark Rg is displayed only in first virtual image 101g as illustrated in FIG. 14A. Then, radial mark Rg is displayed only in second virtual image 201g and reaches object P, as illustrated in FIG. 14B.

Thus, when controller 500 detects the object, first virtual image 101g and second virtual image 201g include radial mark Rg originating from object P in second virtual image 201g. With radial mark Rg, the user's line of sight can be guided from first virtual image 101g to object P in second virtual image 201g.

Radial mark Rg may be simultaneously displayed in both first virtual image 101g and second virtual image 201g. In this case, the warning mark may be displayed in first virtual image 101g as mentioned above.

### Embodiment 10

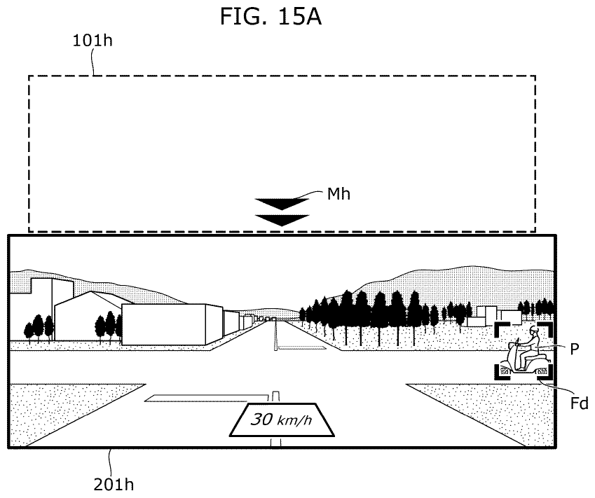

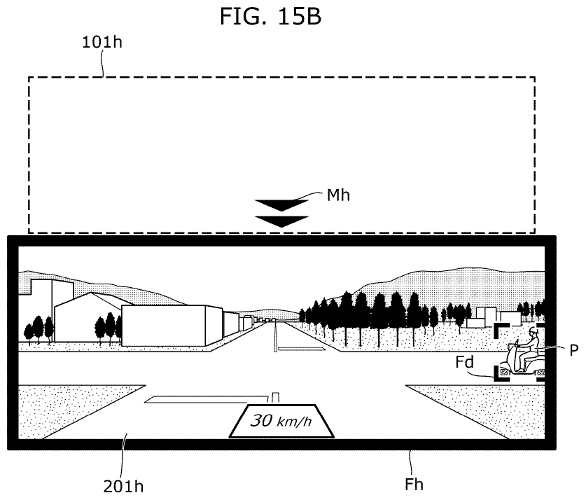

In Embodiment 10, a display example of the first virtual image and the second virtual image will be described. FIGS. 15A and 15B are explanatory diagrams illustrating a display example according to Embodiment 10. In Embodiment 6 described above, guidance mark Md guides the user's line of sight from first virtual image 101d to object P in second virtual image 201d. In Embodiment 10, guidance mark Mh guides the user's line of sight from first virtual image 101h to second virtual image 201h.

As illustrated in FIG. 15A, when controller 500 detects an object around vehicle 1, controller 500 causes second display device 200 to project second virtual image 201h including object P captured by imager 550, and causes first display device 100 to project first virtual image 101h including guidance mark Mh. Specifically, guidance mark Mh is an arrow located in a lower center part of first virtual image 101h. Guidance mark Mh may be in any form and position as long as it can guide the user's line of sight to second virtual image 201h.

Thus, when controller 500 detects the object, second virtual image 201h including object P and first virtual image 101h including guidance mark Mh are projected, so that the user's line of sight can be guided from first virtual image 101h to second virtual image 201h. Since the user's line of sight is simply guided to second virtual image 201h, the guidance of the user's line of sight can be simplified.

As illustrated in FIG. 15B, controller 500 may cause second display device 200 to project second virtual image 201h including frame image Fh at the outer periphery of second virtual image 201h including object P. Frame image Fh may be a frame image formed on part of the outer periphery of second virtual image 201h or a frame image continuously formed on the entire outer periphery. In this embodiment, frame image Fh is continuously formed on the entire outer periphery of second virtual image 201h. Since second virtual image 201h including object P and frame image Fh is projected, the user can quickly recognize that second virtual image 201h includes object P by viewing frame image Fh. While highlight frame Fd is displayed around object P in FIG. 15B, highlight frame Fd may be omitted. Thus, especially when there are a plurality of objects, the user's attention can be drawn to entire second virtual image 201h by frame image Fh without guiding the line of sight only to a specific object.

### Embodiment 11

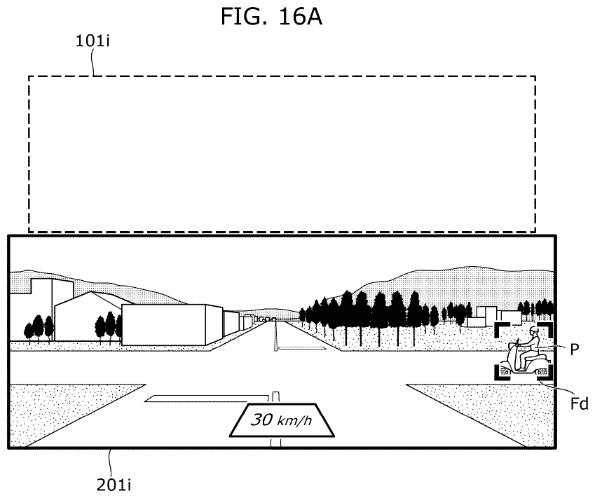

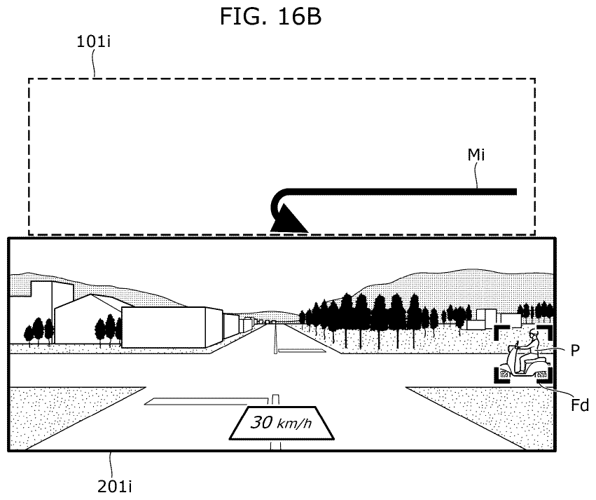

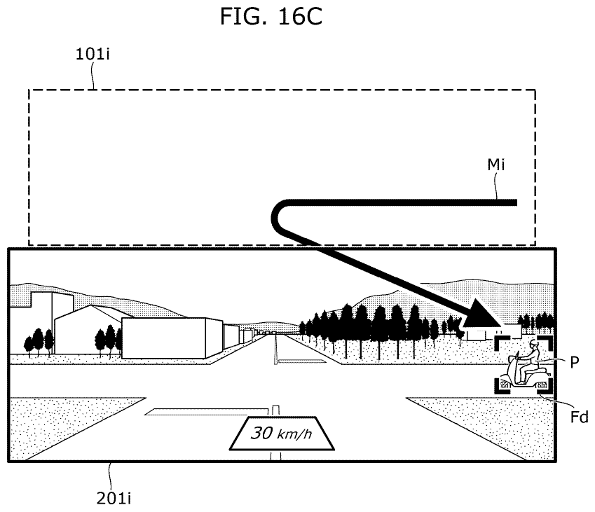

In Embodiment 11, a display example of the first virtual image and the second virtual image will be described. FIGS. 16A to 16C are explanatory diagrams illustrating a display example according to Embodiment 11.

Guidance mark Mi is projected so as to move from an edge part toward center of first virtual image 101i and then move toward object P in second virtual image 201i. FIG. 16A illustrates the state before guidance mark Mi is projected. In FIG. 16A, a surroundings image displayed as second virtual image 201i includes object P and highlight frame Fd.

Next, as illustrated in FIG. 16B, guidance mark Mi moves from the edge part of first virtual image 101i toward the center of first virtual image 101i and then bends toward object P in second virtual image 201i. Here, controller 500 detects the direction from which the object proceeds by performing image processing on the image data captured by imager 550, and causes guidance mark Mi to appear from the edge part of first virtual image 101i corresponding to the direction from which the object proceeds. In FIG. 16B, the direction from which the object proceeds is right, and accordingly guidance mark Mi appears from the right edge part of first virtual image 101i, extends leftward, and bends at the center of first virtual image 101i toward the lower right.

Guidance mark Mi then enters second virtual image 201i and extends toward object P, and finally its tip reaches object P, as illustrated in FIG. 16C. Thus, when controller 500 detects the object, guidance mark Mi is projected so as to move from the edge part of first virtual image 101i toward the center thereof and then move toward object P in second virtual image 201i, thereby guiding the user's line of sight from first virtual image 101i to object P in second virtual image 201i.

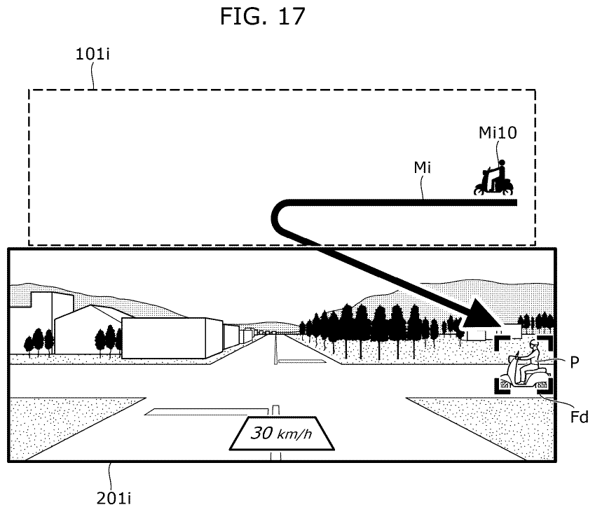

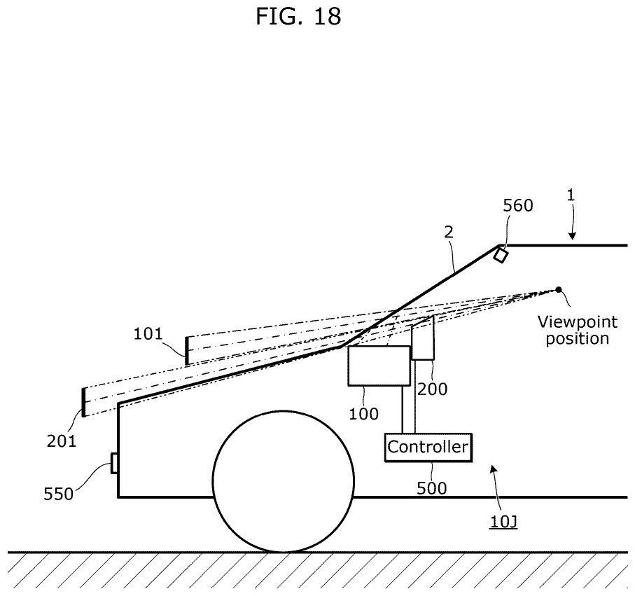

The expression method of guidance mark Mi is not limited as long as it moves from the edge part of first virtual image 101i toward the center thereof and then moves toward object P in second virtual image 201i. FIG. 17 is an explanatory diagram illustrating another display example according to Embodiment 11. As illustrated in FIG. 17, symbol Mi10 imitating the object may be added to guidance mark Mi. In this case, symbol Mi10 may or may not move together with guidance mark Mi.

### Embodiment 12

In Embodiment 12, a display example of the first virtual image and the second virtual image will be described. FIG. 18 is a schematic diagram illustrating display system 10J according to Embodiment 12. Display system 10J according to Embodiment 12 includes imager 560 placed near an upper part of windshield 2 inside vehicle 1. Imager 560 is a camera for capturing the user's head and is electrically connected to controller 500.

Controller 500 obtains the image captured by imager 560 and estimates the user's line of sight from the captured image. Specifically, controller 500 performs predetermined image processing on the captured image to extract the driver's pupil and estimate the line of sight from the inclination of the pupil. That is, imager 560 and controller 500 are an example of the second detector according to the present disclosure.

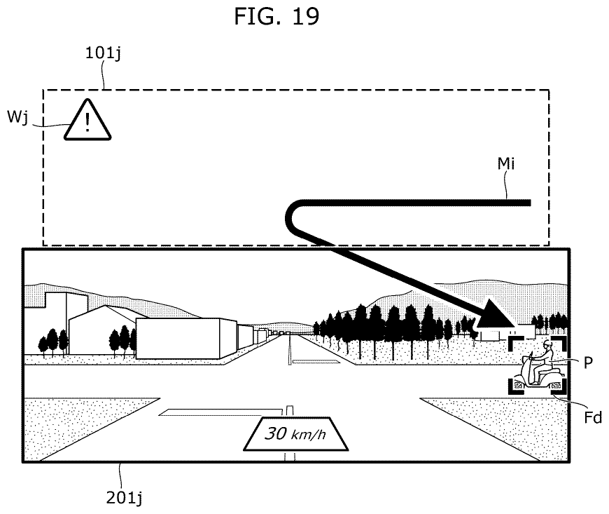

FIG. 19 is an explanatory diagram illustrating a display example according to Embodiment 12. FIG. 19 corresponds to FIG. 16C. As illustrated in FIG. 19, when controller 500 detects an object, controller 500 causes second display device 200 to project second virtual image 201j including object P, and causes first display device 100 to project first virtual image 101j including warning mark Wj at a position corresponding to the detected user's line of sight. In FIG. 19, since the user's line of sight is directed to the left front, warning mark Wj is displayed at the upper left of first virtual image 101j.

Thus, when controller 500 detects the object, second virtual image 201j including object P and first virtual image 101j including warning mark Wj at a position corresponding to the user's line of sight are projected. Hence, the user can quickly recognize that second virtual image 201j includes object P by viewing warning mark Wj.

### Embodiment 13

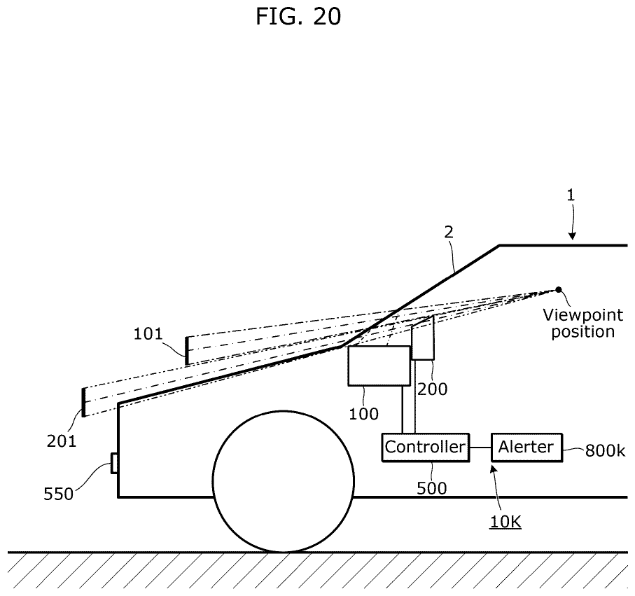

In Embodiment 13, display system 10K including alerter 800k will be described. FIG. 20 is a schematic diagram illustrating display system 10K according to Embodiment 13. Display system 10K according to Embodiment 13 includes alerter 800k that outputs at least one of a warning sound or a warning vibration to the user. Alerter 800k includes at least one of a speaker for outputting the warning sound or a vibration device for outputting the warning vibration. The vibration device is placed at a location where the vibration can be transmitted to the user, such as the steering wheel or seat. Alerter 800k is electrically connected to controller 500.

When controller 500 detects an object, controller 500 causes alerter 800k to output at least one of the warning sound or the warning vibration, and then causes second display device 200 to project second virtual image 201 including object P.

Thus, when an object around vehicle 1 is detected, at least one of the warning sound or the warning vibration is output from alerter 800k, and then second virtual image 201 including object P is projected. Therefore, the user can quickly recognize that second virtual image 201 includes object P by perceiving at least one of the warning sound or the warning vibration.

### (Others)

While a display system according to one or more aspects of the present disclosure has been described above by way of the foregoing embodiments, the present disclosure is not limited to the foregoing embodiments. Other modifications obtained by applying various changes conceivable by a person skilled in the art to the foregoing embodiments and any combinations of the structural elements in different embodiments without departing from the scope of the present disclosure are also included in the scope of one or more aspects of the present disclosure.

While various embodiments have been described herein above, it is to be appreciated that various changes in form and detail may be made without departing from the spirit and scope of the present disclosure as presently or hereafter claimed.

Further Information about Technical Background to this Application

The disclosures of the following patent applications including specification, drawings, and claims are incorporated herein by reference in their entirety: Japanese Patent Application No. 2024-167369 filed on Sep. 26, 2024, and Japanese Patent Application No. 2025-070365 filed on Apr. 22, 2025.

### INDUSTRIAL APPLICABILITY

The present disclosure can be utilized for display systems that display virtual images.

1. A display system comprising:
a first display device that projects a first virtual image in front of a user aboard a vehicle; and
a second display device that projects a second virtual image in front of the user,
wherein the first display device is a head-up display or an electronic mirror-type display device, and
a first viewing distance from the user to the first virtual image is less than a second viewing distance from the user to the second virtual image.

2. The display system according to claim 1,
wherein a distance between the first virtual image and the second virtual image in a side view of the vehicle is within 0.25 diopters.

3. The display system according to claim 1,
wherein the first virtual image and the second virtual image are positioned lower than a viewpoint of the user, and a depression angle of the second virtual image is greater than a depression angle of the first virtual image, and
the first virtual image and the second virtual image are at a same position in a front-rear direction of the vehicle.

4. The display system according to claim 1,
wherein the second display device includes instrument information in the second virtual image.

5. The display system according to claim 1,
wherein the second display device includes a side rear image of the vehicle in the second virtual image.

6. The display system according to claim 1,
wherein the second display device includes a wide-angle image of a front or rear of the vehicle in the second virtual image.

7. The display system according to claim 1,
wherein the second display device includes, in the second virtual image, a blind spot image of a blind spot caused by a pillar of the vehicle.

8. The display system according to claim 1,
wherein the first display device is a combiner-type head-up display.

9. The display system according to claim 1, comprising:
an imager that captures surroundings of the vehicle;
a first detector that detects an object around the vehicle; and
a controller that controls the first display device and the second display device,
wherein when the first detector detects the object, the controller causes the second display device to project the second virtual image including the object captured by the imager, and causes the first display device and the second display device to project the first virtual image and the second virtual image including a guidance mark for guiding a line of sight of the user to the object in the second virtual image, and
the guidance mark is projected to gradually move from the first virtual image toward the object in the second virtual image and gradually decrease in size.

10. The display system according to claim 9,
wherein the controller causes the first display device to project the first virtual image including a warning mark together with the guidance mark, and
the warning mark is removed after the guidance mark moves to the object in the second virtual image.

11. The display system according to claim 9,
wherein the controller causes the second display device to project the second virtual image including a frame image at an outer periphery of the second virtual image including the object.

12. The display system according to claim 11,
wherein the controller causes the first display device to project the first virtual image including part of the frame image.

13. The display system according to claim 1, comprising:
an imager that captures surroundings of the vehicle;
a first detector that detects an object around the vehicle; and
a controller that controls the first display device and the second display device,
wherein when the first detector detects the object, the controller causes the second display device to project the second virtual image including the object captured by the imager, and causes the first display device and the second display device to project the first virtual image and the second virtual image including a radial mark originating from the object in the second virtual image.

14. The display system according to claim 1, comprising:
an imager that captures surroundings of the vehicle;
a first detector that detects an object around the vehicle; and
a controller that controls the first display device and the second display device,
wherein when the first detector detects the object, the controller causes the second display device to project the second virtual image including the object captured by the imager, and causes the first display device to project the first virtual image including a guidance mark for guiding a line of sight of the user to the second virtual image.

15. The display system according to claim 14,
wherein the controller causes the second display device to project the second virtual image including a frame image at an outer periphery of the second virtual image including the object.

16. The display system according to claim 1, comprising:
an imager that captures surroundings of the vehicle;
a first detector that detects an object around the vehicle; and
a controller that controls the first display device and the second display device,
wherein when the first detector detects the object, the controller causes the second display device to project the second virtual image including the object captured by the imager, and causes the first display device and the second display device to project the first virtual image and the second virtual image including a guidance mark for guiding a line of sight of the user to the object in the second virtual image, and
the guidance mark is projected to move from an edge part of the first virtual image toward a center of the first virtual image and thereafter move toward the object in the second virtual image.

17. The display system according to claim 1, comprising:
an imager that captures surroundings of the vehicle;
a first detector that detects an object around the vehicle;
a second detector that detects a line of sight of the user; and
a controller that controls the first display device and the second display device,
wherein when the first detector detects the object, the controller causes the second display device to project the second virtual image including the object captured by the imager, and causes the first display device to project the first virtual image including a warning mark at a position corresponding to the line of sight of the user detected by the second detector.

18. The display system according to claim 1, comprising:
an imager that captures surroundings of the vehicle;
a first detector that detects an object around the vehicle;
an alerter that outputs at least one of a warning sound or a warning vibration to the user; and
a controller that controls the first display device, the second display device, and the alerter,
wherein when the first detector detects the object, the controller causes the alerter to output at least one of the warning sound or the warning vibration, and thereafter causes the second display device to project the second virtual image including the object captured by the imager.
